(19) United States
(12) Patent Application Publication
(10) Pub. No.: US 2008/0260921 A1
(43) Pub. Date: Oct. 23, 2008

(54) Process for Producing Ready-to-Eat Chow Mein (Fried Noodle)

(75) Inventors: Yoshiyuki Imanishi, Osaka (JP); Toshiaki Sonoda, Osaka (JP); Hirotake Yamada, Osaka (JP)

Correspondence Address: William L. Androlia;Quinn Emanuel Urquhart Oliver & Hedges, 865 S. Figueroa Street, 10th Floor, Los Angeles, CA, 90007, US

(73) Assignee: Acecook Co., Ltd.

(21) Appl. No.: 10/571,731

(22) PCT Filed: May 31, 2005
(86) PCT No.: PCT/JP05/09958

§ 371 Date: Mar. 14, 2006

(30) Foreign Application Priority Data
Nov. 17, 2004 (JP) 2004-332750

(51) Int. Cl. A23L 1/162; A23L 1/01

(52) U.S. Cl. 426/302; 426/557

(57) ABSTRACT

The present invention provides a process for producing ready-to-eat chow mein which can afford such a feeling and fragrant flavor as experienced when we eat the chow mein baked on a hot iron plate. It mixes floor, starch, table salt, water and the like to form a material and kneads the material. The thus kneaded material is extended and rolled to a predetermined thickness to form a noodle blank. This noodle blank is cut to a predetermined width and waved to form lines of noodle. These lines of noodle are converted to α-state with a steamer. A seasoning liquid of a predetermined concentration is sprayed to these lines of noodle and then are molded into a predetermined shape. Thereafter, they are oil fried to produce a mass of seasoned and fried noodles. This seasoned and oil fried mass of noodles is baked until it has its surface heated up to 150 degrees C. to 240 degrees C. so as to brown it.

### TECHNICAL FIELD

The present invention concerns a process for producing browned ready-to-eat chow mein.

### BACKGROUND ART

Conventionally, commercially available oil fried ready-to-eat chow mein is usually prepared by: mixing floor, starch, table salt, water and the like and kneading the thus mixed material; extending this material to 2 sheets of wide noodle blank; combining them into one sheet; and rolling this sheet to a predetermined thickness through several sets of rolls. Subsequently, this noodle blank is cut to a predetermined width by a cutter and waved to form creped lines of noodle peculiar to the ready-to-eat chow mein. Next, the creped lines of noodle are steamed by a steamer and then the steamed lines of noodle are cut to a desired size. The cut and steamed lines of noodle are stuffed into a mold framework of a fixed shape and are molded to a predetermined form. Thereafter, the molded lines of noodle are oil fried.

However, the thus produced ready-to-eat chow mein is returned to its original state by pouring boiling water and is got rid of the boiling water. Then it is mixed with sauce for chow mein contained in a bag attached separately and dried green laver powder is sprinkled thereon to eat. However, it lacks such a fragrance as the original chow mein baked on a hot iron plate has.

Then in order to apply such a fragrance as occurring when baked on the hot iron plate, there was proposed a process for preparing ready-to-eat chow mein which bakes fried ready-to-eat chow mein to brown its surface by a gas burner, infrared rays or the like (for instance, see Patent Literature 1).

Patent Literature 1: Patent Public Disclosure No. 2002-119234

### DISCLOSURE OF THE INVENTION

### Problem the Invention Attempts to Solve

However, like the above-mentioned process for producing ready-to-eat chow mein, baking the fried ready-to-eat chow mein with a gas burner or the like to brown can afford fragrant flavor. But the flavor is only the flavor that the floor of a main material offers when it is browned. It cannot afford such a peculiar complicated tasty flavor as occurring from the browned sauce and other materials which we feel upon eating the chow mein cooked on a hot iron plate.

The present invention has been created so as to solve the above-mentioned problems. And it has an object to provide a process for producing a ready-to-eat chow mein which makes the ready-to-eat chow mein present such a tasty feeling and fragrant flavor as we experience when we eat the chow mein baked on the hot iron plate by seasoning the lines of noodle with Worcestershire sauces and flavorings each of which mainly consists of one or at least two of sugars, amino acids, hydrolyzed protein, yeast extracts, extracts of vegetables and meats, spices and the like and oil frying them to obtain a seasoned and fried mass of noodles and then baking the thus obtained mass of noodles.

### Means for Accomplishing the Object

The process for producing ready-to-eat chow mein according to the present invention is characterized by molding lines of noodle seasoned to a predetermined shape to form a mass of noodles and oil frying the mass of noodles to make a seasoned and fried mass of noodles and by baking the surface of the seasoned and fried mass of noodles to brown it.

As one preferable way, in order to obtain the above-mentioned seasoned and fried mass of noodles, the process of producing the ready-to-eat chow mein according to the present invention mixes floor, starch, table salt, water and the like and kneading the thus mixed material, extending this material and rolling it to a predetermined thickness to form a noodle blank, cutting this noodle blank to a predetermined width and waving it to form lines of noodle, converting these lines of noodle to α-state with a steamer, spraying seasoning liquid of a predetermined concentration to the lines of noodle, molding the lines of noodle into a predetermined shape and then oil frying them. Further, the floor, starch, table salt, water and the like are mixed with seasoning liquid of a predetermined concentration. The thus made material is kneaded and then is extended and rolled to a predetermined thickness to form a noodle blank. This noodle blank is cut to a predetermined width and waved to form lines of noodle. These lines of noodle are converted to α-state with a steamer and then are molded into a predetermined shape. Thereafter, they may be oil fried so as to obtain a seasoned and fried mass of noodles.

In these cases, as for the seasoning liquid, it is possible to use Worcestershire sauces and flavorings each of which mainly consists of one or at least two of sugars, amino acids, hydrolyzed proteins, extracts of vegetables, extracts of meats, yeast extracts, spices and the like.

The seasoned and fried mass of noodles is preferably baked so as to have its surface temperature increased up to 150 degrees C. to 240 degrees C. to brown the surface.

### EFFECT OF THE INVENTION

Baking the seasoned and fried mass of noodles heats and bakes the seasoning components so as to be able to obtain the ready-to-eat chow mein which can afford such fragrance and elastic feeling as occurring when the original chow mein is cooked on the hot iron plate. The fragrant flavor occurring by baking can inhibit the oily taste peculiar to the ready-to-eat oil fried chow mein.

Seasoning, particularly the seasoning with sugars and amino acids accelerates the baking effect of the noodles owing to the carbonyl reaction, thereby enabling the baked portion to appear beautiful and uniformly browned. Besides, the browned portions can afford the peculiar elastic feeling that we experience when we eat the boiled chow mein baked on the hot iron plate.

In the case of using and baking one of the seasoning components, sugars, amino acids, spices, extracts of vegetables, extracts of meats, yeast extracts, hydrolyzed proteins and the like included in the Worcestershire sauces and flavorings, it is possible to obtain the ready-to-eat chow mein which can present such fragrant flavor and elastic feeling as appearing when the original chow mein is cooked on the hot iron plate. Further, when using the Worcestershire sauces and flavorings consisting of the mixture of at least two components each of which has seasoning effect, it exerts synergistic effect to the fragrant flavor occurring after the chow mein has been baked. Thus it is possible to obtain ready-to-eat chow mein which can more enhance the fragrant flavor occurring when cooking the original chow mein on the hot iron plate.

When the seasoned and fried mass of noodles has its surface temperature baked only to below 150 degrees C., it is insufficiently browned to result in failing to afford fragrance and comfortable elastic feeling. On the other hand, when the seasoned and fried mass of noodles has its surface temperature baked to over 240 degrees C., it has its surface excessively browned to result in failing to present good appearance and further producing smell of something burning in the aspect of flavor. Thus not preferable. However, if the seasoned and fried mass of noodles is baked until its surface temperature comes to 150 degrees C. to 240 degrees C. so as to brown its surface can produce ready-to-eat chow mein constant in quality which can always afford stably and reliably such an elastic feeling and fragrance as experienced when baking the original chow mein on the hot iron plate

### MOST PREFERRED EMBODIMENT FOR PUTTING THE INVENTION INTO PRACTICE

A process for producing ready-to-eat chow mein (fried noodle) according to the present invention first prepares a seasoned and oil fried mass of noodles. The seasoned and fried mass of noodles is prepared in the following way.

The starting materials of floor, starch, table salt, water and the like are mixed by a mixer and the thus mixed materials are kneaded. This forms the mesh structure of the gluten. The mixing time is about 15 to 20 mins. Next, the kneaded material is extended to two sheets of noodle blank, which are combined into one sheet. Then the sheet is rolled to a thickness of about 1 mm through several sets of rolls. Subsequently, the noodle blank is cut to a predetermined width by a cutter and is waved to form creped lines of noodle, peculiar to the ready-to-eat chow mein, so that the subsequent steps can be effectively conducted. Next, the creped lines of noodle are steamed by a continuous steamer to covert them to α-state. Commonly, they are steamed up within 1 to 2 mins. with steam of 100 degrees C.

Then seasoning liquid of a predetermined concentration is sprayed to the lines of noodle converted to α-state so as to season them. As for the seasoning liquid, the Worcestershire sauces or flavorings, each of which mainly consists of one or at least two of sugars, amino acids, hydrolyzed proteins, extracts of vegetables, extracts of meats, yeast extracts, spices and the like, are used.

Subsequently, loosening is applied so that the lines of noodle can be easily loosened when they are returned to the original state by pouring boiling water. Most of the noodles packaged into cups are loosened noodles. Many of the noodles packed in bags are two-folded noodles which don't undergo the loosening step.

Then these seasoned lines of noodle are cut to 20 to 70 cm so that they come to have a weight for eating once. The cut lines of noodle are stuffed into an oil-frying framework of a fixed form and are molded into a predetermined shape to obtain a seasoned mass of noodles.

Next, the seasoned mass of noodles is passed through oil of 120 to 150 degrees C. for several minutes so as to oil fry it. After it has been oil fried, if necessary, in order to prevent the quality reduction of the fat and oil contained in the noodles and that of the attached soup, it is instantaneously cooled to 30 to 40 degrees C.

The seasoned and fried mass of noodles of the predetermined shape obtained during the above steps is transferred to a baking step to brown its surface. During this baking step, the seasoned and fried mass of noodles is baked until it has its surface temperature raised to 150 degrees C. to 240 degrees C., more preferably to 180 degrees C. to 200 degrees C. by a heat source such as a burner and an oven, so as to brown it. When the mass of noodles has its surface temperature heated to below 150 degrees C., it is not sufficiently browned to result in failing to afford elastic feeling and fragrant flavor. However, the noodle mass can have its surface browned by heating the surface of the noodle mass to at least 150 degrees C. to result in giving good elastic feeling and fragrant flavor. Particularly, if the mass of noodles is baked by having its surface heated to 180 degrees C. to 200 degrees C., it is most ideally browned to produce better outer appearance (degree of the brownish) as well as excellent elastic feeling and fragrance. Thus such temperature range is the most optimum surface temperature of the mass of noodles. However, in the event that the mass of noodles is baked by heating its surface to above 260 degrees C., it has its surface excessively browned to result in offering not only bad outer appearance but also smell of something which is too much burnt in the aspect of flavor.

Baking the seasoned and fried mass of noodles heats and bakes the seasoned components to produce ready-to-eat chow mein which can give such fragrant flavor and comfortable elastic feeling as appearing when the original chow mein is cooked on the hot iron plate. Further, when it is baked, it affords fragrant flavor, which inhibits the oily taste peculiar to the ready-to-eat fried chow mein.

As regards the way to season the lines of noodle, there is a way of immersing the lines of noodle into seasoning liquid other than spraying the seasoning liquid to them as mentioned above.

Another way of seasoning is to add the seasoning liquid of a predetermined concentration to the materials during the step of mixing floor, starch, table salt, water and the like and kneading them.

The seasoning liquid to be used in these cases is the Worcestershire sauces or flavorings each of which mainly consists of one or at least two of sugars, amino acids, hydrolyzed proteins, extracts of vegetables, extracts of meats, yeast extracts, spices and the like as well as the above-mentioned embodiment.

Besides, after the floor, starch, table salt, water and the like have been mixed with the seasoning liquid and the mixture material has been kneaded, this material is extended and rolled to a predetermined thickness to form a noodle blank, which is cut to a predetermined width and is waved to form lines of noodle, and subsequently the lines of noodle are converted to α-state by a steamer and then are molded into a predetermined shape. Thereafter, they are oil fried to obtain the seasoned and fried mass of noodles as well as the above-mentioned embodiment.

In the event that the seasoning components included in the Worcestershire sauces or flavorings are, particularly sugars and amino acids, as mentioned above, the baking effect of the noodles is accelerated owing to the aminocarbonyl reaction, thereby making it possible to obtain noodles baked beautifully and browned uniformly.

Additionally, in the case where one of the sugars, amino acids, spices, extracts of vegetables, extracts of meats, yeast extracts, and hydrolyzed proteins is used and baked, it is possible to obtain ready-to-eat chow mein which can afford such a fragrant flavor and comfortable elastic feeling as appearing when the original chow mein is cooked on the hot iron plate. Besides, when using the Worcestershire sauces or flavorings consisting of the mixture produced by mixing at least two components each of which has seasoning effect, it presents synergic effect to the fragrant flavor appearing after baked, thereby enabling the fragrant flavor which appears upon cooking the original chow mein on the hot iron plate to be further enhanced.

### Example 1

Kneading water which consists of 1.5 g of blackish water and 20 g of table salt dissolved therein was added to the starting powder material which consists of 900 g of floor and 100 g of starch and was mixed therewith and kneaded for 15 mins. by a mixer to produce a material. This material was extended and rolled to form a noodle blank. The noodle blank was cut to a predetermined width and was waved to form lines of noodle.

Subsequently, these lines of noodle were converted to α-state with a steamer. 30 ml of the following seasoning liquid adjusted to a predetermined concentration was sprayed to the lines of noodle to season them. Thereafter, the seasoned lines of noodle were thrown into an oil frying framework to mold them into a predetermined shape and then were oil fried. The thus obtained mass of noodles was baked under the following conditions. As for the flavorings, there were prepared several kinds of seasoning liquid (see Table 2) each of which contains sugars and the like seasoning components shown in the below Table 1 and having seasoning effect and has its concentration adjusted to include them in the ratios of 0.1 wt %, 0.5 wt %, 1.0 wt %, 2.0 wt %, 3.0 wt %, 5.0 wt % and 7.0 wt % for 100 g of oil fried mass of noodles.

Table 1

Table 2

(Baking Conditions)

Heat source; Shubunk burner made by Linnai Co., Ltd.

Burner temperature; about 700 degrees C.

Distance from the burner to the fried mass of noodles; 75 mm

Atmospheric temperature in the vicinity of the surface of the mass of noodles: about 220 degrees C. Baking temperature; Baked to have its surface temperature raised to about 200 degrees C. under the above conditions.

<Evaluation after Tasting>

The ready-to-eat chow mein flavored with the seasoning liquid shown in the above Table 2 was returned to the original state by pouring boiling water and was got rid of the boiling water for supplying it to eat. Tens of panelists made sensuous evaluation in accordance with the following standards of evaluation.

Standard of Evaluation>

The sensuous evaluation was made in accordance with the following standards and the respective average points are shown in the above Table 2.

5 . . . Being very fragrant and affording such flavor as the baked chow mein; very preferable.
4 . . . Being fragrant and being felt to have such flavor as the baked chow mein.
3 . . . Being fragrant but having not such flavor as the baked chow mein.
2 . . . Being felt slightly fragrant.
1 . . . Being not different from the unbaked chow mein and besides having no fragrance.

The following facts can be seen from the result of the sensuous evaluation shown in the above Table 2.
With the chow mein unflavored, fragrance was felt but it was carbonate order which occurs when the floor itself was burnt, not the fragrant flavor appearing when the chow mein is baked on the hot iron plate.
When baking the noodle seasoned by spraying sugars, amino acids, hydrolyzed proteins, extracts of vegetable, extracts of meats, yeast extracts, spices and the like, the seasoning components themselves present fragrant flavor, thereby making it possible to obtain fragrant noodles as tasty as the original chow mein.
As to the sugars, glutamic acids Na, hydrolyzed proteins (vegetables), yeast extracts, garlic used in the present Example, when each of them is added in the ratio of 1%, it is possible to obtain such noodles as the baked chow mein, which are the most excellent in flavor and fragrant upon being baked.
With the extracts of onion added in the ratio of 0.5%, the flavor is the best. With the hydrolyzed proteins (animals) and the extracts of chicken added in the respective ratios of 3% and 5%, it is possible to obtain the noodles which have the best flavor and are fragrant as if they were baked on the hot iron plate.
If the seasoning components are added in the ratios exceeding the optimum ones, they are progressively increasing in amount to result in obtaining noodles which smell too much as if something were burning to feel bitter and uncomfortable. Thus unfavorable. Besides, the seasoning components give their flavor itself so much that the balance of taste is broken to result in lacking the absolute deliciousness as the chow mein. Therefore, unfavorable.

### Example 2

Kneading water which consists of 1.5 g of blackish water and 20 g of table salt dissolved therein was added to the starting powder material which consists of 900 g of floor and 10 g of starch and was mixed therewith and kneaded for 15 mins. by a mixer to produce a material. This material was extended and rolled to form a noodle blank. The noodle blank was cut to a predetermined width and was waved to form lines of noodle. At this time, added to the material is the Worcestershire sauce (see Table 3) which contains the seasoning components in the respective ratios of 0.2 wt %, 0.5 wt %, 1.0 wt %, 3.0 wt %, 5.0 wt %, 7.0 wt %, 9.0 wt %, 11.0 wt %, and 13.0 wt % for 100 g of the fried mass of noodles and they were kneaded together. Subsequently, the mass of noodles was converted to α-state with a steamer and was thrown into an oil frying framework to mold them into a predetermined shape and then was oil fried. The thus obtained mass of noodles was baked under the same conditions as those of Example 1.

As for the Worcestershire sauce, the “Kagome Sauce Worcestershire JAS superior” made by Kabushiki Kaisha KAGOME was used.

### Example 3

The ready-to-eat chow mein was prepared in the same manner as in Example 2 except that the seasoning liquid adjusted to contain the Worcestershire sauce for eating once in the same quantity as that of 0.2% concentration in Example 2 kneaded into the material was sprayed to the α-state lines of noodle, which were then oil fried and baked.

<Evaluation after Tasting>

Each of the ready-to-eat chow mein obtained in Examples 2 and 3 was returned to the original state by pouring boiling water and was got rid of the boiling water for supplying it to eat. Tens of panelists made sensuous evaluation in accordance with the following standards of evaluation.

<Standard of Evaluation>

The sensuous evaluation was made in accordance with the following standards and the respective average points are shown in the below Table 3.

### Flavoring

5 . . . Being very fragrant and having such flavor as the baked original chow mein; very preferable.
4 . . . Being fragrant and being felt to have such flavor as the baked chow mein.
3 . . . Being fragrant but having not such flavor as the baked chow mein.
2 . . . Being felt slightly fragrant.
1 . . . Being not different from the unbaked chow mein and besides having no fragrance.
How the feeling was upon eating.
5 . . . Felt that the surface was so hard and elastic as the steamed chow mein cooked on the hot iron plate. Very favorable and could feel as if the original chow mein were cooked.
4 . . . Felt that the surface was so hard and elastic and could feel as if the original chow mein were cooked.
3 . . . Felt that the surface was slightly elastic.
2 . . . Being not different from the conventional ready-to-eat chow mein.
Rather, felt slightly worse.
1 . . . Low in value of goods. Felt worst.

Table 3

The following fact can be seen from the sensuous evaluation in the above Table 3.

With the chow mein unseasoned, it is possible to obtain the fragrant chow mein when it is baked, but the fragrance is that of the floor or the like baked.

It is possible to obtain by seasoning with the Worcestershire sauce and baking the noodles, such chow men as being fragrant and good in flavor and further felt like that cooked on the hot iron plate. As the concentration of the Worcestershire sauce is progressively increasing, the more fragrance is added. The concentration of 7.0% offers a remarkable effect.

With the concentration of Worcestershire sauce exceeding 11.0%, the flavor of the baked Worcestershire occurs too much to offer good flavor. Further, the balance of taste is broken to result in failing to afford the absolute deliciousness as the goods.

This is the same to the feeling experienced when it is eaten. With the concentration of Worcestershire sauce progressively increasing, the higher evaluation can be acquired. 7.0% concentration of Worcestershire sauce offers the greatest effect.

With the concentration of Worcestershire sauce exceeding 11.0%, the acid action of the Worcestershire sauce inhibits the formation of gluten of the noodle to produce the noodle which gives sticky weak feeling and therefore has low value of goods to an extent higher than giving effect exerted by baking.

As for the seasoning way, either kneading the seasoning component into the material or spraying them to the lines of noodle can afford the same effect.

In addition, when the seasoned noodles are baked, it can suppress the peculiar oily taste strongly felt when eating the oil fried ready-to-eat chow mein.

TABLE 1

| Kind of Component | | Name of Maker | Trade Name |
|---|---|---|---|
| Sugars | Sugar | K.K. Itohchu Seito | JOHAKUTO |
| Amino Acids | Glutamic Acid Na | K.K. Ajinomoto | AJINOMOTO RC |
| Hydrolyzed Proteins | Hydrolyzed Protein (Vegetable) | K.K. Ajinomoto | AJIZO-KF |
| | Hydrolyzed Protein (Animal) | K.K. Riken Vitamin | HAP-L |
| Extracts of Vegetables | Onion Extract | K.K. Nikken Food | ONION EKIS |
| Extracts of Meats | Chicken Extract | K.K. Ariake Japan | CHICKEN EKIS 7051 |
| Yeast Extracts | Yeast Extract | K.K. Takeda Kirin Food | KOUMI (PASTE) |
| Spices | Garlic | K.K. Riken Kagaku Kogyo | GARLIC PASTE S |

TABLE 2

| | Not | | | | | | | |
|---|---|---|---|---|---|---|---|---|
| | Added | 0.1% | 0.5% | 1% | 2% | 3% | 5% | 7% |
| Not Added | 2.5 | — | — | — | — | — | — | — |
| Sugar | — | 3.0 | 3.5 | 4.2 | 4.0 | 4.0 | 3.7 | — |
| Glutamic Acid Na | — | 3.1 | 3.7 | 4.6 | 4.5 | 4.1 | 4.0 | — |
| Hydrolyzed Protein | — | 3.2 | 3.9 | 4.7 | 4.6 | 4.5 | 4.1 | — |
| (Vegetable) | | | | | | | | |
| Hydrolyzed Protein | — | 3.0 | 3.8 | 4.0 | 4.4 | 4.5 | 4.2 | 3.9 |
| (Animal) | | | | | | | | |
| Onion Extract | — | 3.7 | 4.5 | 3.8 | 3.2 | 2.7 | — | — |
| Chicken Extract | — | 3.0 | 3.5 | 4.0 | 4.3 | 4.3 | 4.8 | 4.5 |
| Yeast Extract | — | 3.2 | 4.0 | 4.7 | 4.2 | 4.0 | 3.6 | — |
| Garlic | — | 3.2 | 4.0 | 4.5 | 4.4 | 4.2 | 3.9 | — |

Evaluated up to 7% section as to hydrolyzed protein (animal) and chicken extract.

TABLE 3

| | | | | | Feeling |
|---|---|---|---|---|---|
| | Concentration of | | | | Upon |
| How to Season | Seasoning Component | | Baking | Flavor | Eating |
| Unseasoned | | 0% | No. | 2.0 | 2.3 |
| Kneaded | Sauce | 1.0% | No. | 2.4 | 2.4 |
| Kneaded | Sauce | 7.0% | No. | 3.4 | 2.6 |
| Unseasoned | | 0% | Yes. | 2.7 | 2.7 |
| Sprayed | Sauce | 0.2% | Yes. | 3.0 | 3.4 |
| Kneaded | Sauce | 0.2% | Yes. | 2.9 | 3.1 |
| Kneaded | Sauce | 0.5% | Yes. | 3.6 | 3.4 |
| Kneaded | Sauce | 1.0% | Yes. | 4.1 | 3.8 |
| Kneaded | Sauce | 3.0% | Yes. | 4.3 | 3.6 |
| Kneaded | Sauce | 5.0% | Yes. | 4.8 | 4.2 |
| Kneaded | Sauce | 7.0% | Yes. | 4.8 | 4.3 |
| Kneaded | Sauce | 9.0% | Yes. | 4.3 | 3.7 |
| Kneaded | Sauce | 11.0% | Yes. | 4.0 | 3.2 |
| Kneaded | Sauce | 13.0% | Yes. | 3.3 | 2.5 |

1: A process of producing ready-to-eat chow mein (fried noodle) comprising the steps of molding seasoned lines of noodle into a predetermined shape to form a mass of noodles and oil frying the mass of noodles to produce a seasoned and oil fried mass of noodles; and baking the surface of this seasoned and oil fried mass of noodles to brown it.

2: The process of producing ready-to-eat chow mein as set forth in claim 1, wherein the seasoned and oil fried mass of noodles is prepared by the steps of:
mixing floor, starch, table salt, water and the like to make a material and kneading the material;
extending and rolling this material to a predetermined thickness to form a noodle blank;
cutting the noodle blank to a predetermined width and waving it to form lines of noodle;
converting these lines of noodle to α-state with a steamer;
spraying seasoning liquid of a predetermined concentration to the lines of noodle;
molding them to a predetermined shape; and
oil frying them.

3: The process of producing ready-to-eat chow mein as set forth in claim 1, wherein the seasoned and oil fried mass of noodles is prepared by the steps of:
mixing floor, starch, table salt, water and the like together with seasoning liquid of a predetermined concentration to make a material and kneading the material;
extending and rolling this material to a predetermined thickness to form a noodle blank;
cutting the noodle blank to a predetermined width and waving it to form lines of noodle;
converting these lines of noodle to α-state with a steamer;
molding them to a predetermined shape; and
oil frying them.

4: The process for producing the ready-to-eat chow mein as set forth in claim 2 or 3, wherein Worcestershire sauces or flavorings which mainly consists of one or at least two of sugars, amino acids, hydrolyzed proteins, extracts of vegetables, extracts of meats, yeast extracts and spices are used for the seasoning liquid.

5: The process for producing the ready-to-eat chow mein as set forth in claim 1 or 2, wherein the seasoned and oil fried mass of noodles is baked to have its surface temperature increased up to 150 degrees C. to 240 degrees C. so as to brown the surface.

6: The process for producing the ready-to-eat chow mein as set forth in claim 3, wherein the seasoned and oil fried mass of noodles is baked to have its surface temperature increased up to 150 degrees C. to 240 degrees C. so as to brown the surface.

7: The process for producing the ready-to-eat chow mein as set forth in claim 4, wherein the seasoned and oil fried mass of noodles is baked to have its surface temperature increased up to 150 degrees C. to 240 degrees C. so as to brown the surface.
